(19) United States
(12) Patent Application Publication
(10) Pub. No.: US 2010/0241644 A1
(43) Pub. Date: Sep. 23, 2010

(54) GRAPH QUERIES OF INFORMATION IN RELATIONAL DATABASE

(75) Inventors: Thomas E. Jackson, Redmond, WA (US); Chris Demetrios Karkanias, Sammamish, WA (US); David G. Campbell, Sammamish, WA (US); Stuart M. Bowers, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/407,767

(22) Filed: Mar. 19, 2009

(51) Int. Cl. G06F 17/30; G06F 7/00

(52) U.S. Cl. 707/760; 707/E17.045; 707/E17.014; 707/E17.136

(57) ABSTRACT

In one example, information may be stored in a relational database. The information in the database may define a graph, in the sense that the information may define a set of entities and relations between the entities. A user may want to query the information using a graph-based query language. A graph query engine may receive the query, and may convert the query into a relational query language, for execution by the relational database. The relational database may calculate views of the underlying tables. Each view corresponds to a particular relation, and the rows in each view are pairs of entities to which the relation applies. Since the views correspond very closely to the specification of a graph, the graph-based query may be translated into a relational query that performs relational algebraic operations on the views in order to answer the graph-based query.

### BACKGROUND

Relational databases implement a model in which data is stored in tables, and in which a schema defines the relationships between the tables. Relational databases typically provide query processors, which answer queries written in a relational query language, such as Structured Query Language (SQL). Relational query processors execute SQL queries by performing various relational algebraic operations on the tables in the database.

While relational databases provide a powerful model for representing and querying data, there are other models. For example, the Resource Description Framework (RDF) provides a graph-based model, in which information comprises a set of entities, and directed binary relationships between pairs of entities. A generalized graph is a set of vertices connected by a set of (possibly labeled) directed edges. Thus, in RDF, entities are the vertices of the graph, and relationships between the vertices are labeled directed edges. So, “John” and “the car” could be two entities, and “owns” could be a relationship between the entities (e.g., “John owns the car”). There are certain query languages associated with graph based models, such as SPARQL (which stands, recursively, for “SPARQL Protocol and RDF Query Language”).

SPARQL and other graph query languages provide a simple way to query graph-based information in a way that leverages the graph structure of that information. In some cases, one may want to use the graph-based model to query information that is stored in a relational database. That is, the information stored in a relational database may lend itself well to being modeled as a graph, and one may want to use a graph query language like SPARQL to access the information, and to perform graph-like reasoning on the information.

### SUMMARY

In a relational database, views may be created that correspond to the subject/predicate/object triples that define a graph. A graph query (e.g., a SPARQL query) may then be converted into a relational query (e.g., a SQL query), which may be answered by performing operations on the views.

The information stored in a relational database may define a graph. A graph is a set of vertices in which pairs of the vertices are connected by labeled directed edges. Each entity may be a vertex in the graph. If a predicate has one of the entities as its subject and another entity as its object, then the predicate defines a directed edge from the subject vertex to the object vertex. The label of the edge is the name of the predicate. For each predicate defined by the information stored in the database, a view may be created. The view may have a column for the subjects of the predicate, and a column for the objects of the predicate. Thus, for a given predicate, it is possible to determine, through the view, which pairs of subjects and objects the predicate applies to.

In order to answer a graph query, the graph query is converted into a relational query that specifies relational operations to be performed on the views. The query is provided to a relational query processor, which uses the views to generate a result.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example system in which graph queries may be processed on information that is stored in a relational database.

FIG. 2 is a block diagram of an example in which data stored in tables may be used to define views.

FIG. 3 is a block diagram of an example query that may be performed using the views described herein.

FIG. 4 is a flow diagram of an example process in which views may be updated and/or created.

FIG. 5 is a flow diagram of an example process in which a graph query may be processed.

FIG. 6 is a block diagram of example components that may be used in connection with implementations of the subject matter described herein.

### DETAILED DESCRIPTION

Predicate relation tuples (PRTs) are data constructs that express relationships between entities. A PRT expresses the fact that a particular predicate describes the relationship between a plurality of entities. The Resource Description Framework (RDF) is an example of a PRT data model that allows facts to be expressed about resources. In RDF, a fact is expressed in the form of a triple. A triple has a subject, a predicate, and an object. For example, “Alice owns the Buick” is an English-like expression of a triple. In this example, “Alice” is the subject, “owns” is the predicate, and “the Buick” is the object. A database of RDF facts defines a directed graph (or, perhaps, two or more unconnected directed graphs), in which each subject or object is a node, and the predicate that relates the subject to the object is a labeled directed edge. RDF is often associated with a particular extensible Markup Language (XML) format, although RDF data can be expressed in various ways and is not limited to any particular format. In the description herein, RDF facts may be represented formally using the syntax “predicate(subject,object)”.

RDF is generally associated with the SPARQL query language. While RDF is not synonymous with SPARQL or any particular query language, SPARQL is an example query language that may be used to query a database of RDF facts. SPARQL allows programmers to specify various types of reasoning to be performed on the graph structure defined by RDF facts. (SPARQL is sometimes referred to as an example of a “graph query language.”) For example, if a database contains the facts “Alice owns the Buick” (owns(“Alice”, “the Buick”)), and “the Buick has mileage of 40 miles per gallon” (hasMileage(“the Buick”, “40”)), then it is possible to write a SPARQL query that returns the mileage of Alice's car. In general, SPARQL is an example of a graph query language, and RDF is an example of a PRT data model. The subject matter herein may be used with any graph query language, or any PRT data model.

A PRT is one type of data model. Another such model is the relational model implemented by a relational database. A relational database stores information in tables (sometimes called “relations”). Each table is defined as having one or more columns, each of which has a name (sometimes called an “attribute”). For a table that has n columns, the table comprises one or more ordered n-tuples of data. Each of the n-tuples is typically described as a row of the table. So, if a table has three columns named “customer name”, “bank account number”, and “balance”, then an example row of the table might be the 3-tuple (<John Smith>, <12345>, <$5,000>). A schema defines the particular tables that are supported in a given relational database, and also defines the relationship between the data in the various tables.

In some cases, a relational database may be used to store the information that defines RDF triples or other PRTs. For example, lists of entities, and relationships between the entities, may be stored in various types of tables in a relational database, thereby representing the triples, in some manner, in the relational database. Like other forms of RDF data, the triples define a graph that shows the relationships between various entities. One may want to execute queries that perform various types of reasoning on the graph. Relational databases typically expose a relational query language—e.g., Structured Query Language, or “SQL”—which provides powerful features to access, and to perform various types of reasoning on, the tables in a relational database. However, relational query languages like SQL are less effective for performing reasoning on the graph structure represented by PRTs. SQL implements relational algebraic operations, such as the various types of joins. These operations perform reasoning on the tables, and relationships between the tables, in a relational database. However, depending on the way in which the graph structure is represented by the data in the relational tables, relational query languages may be ineffective at probing the structure of that graph. One may want to execute SPARQL queries (or graph queries specified in some other language) that perform reasoning on the graph structure represented by the information contained in the tables.

The subject matter herein provides a way to perform graph queries on information that is represented in the form of a relational database.

For each predicate that can be represented in the graph, a view in the relational database is calculated. The view may take the form of a two-column table, where the two columns are the subjects and objects of a specific predicate. Thus, each row of the view is a subject/object pair for which a given predicate has been asserted. Using these views, graph queries can be evaluated by performing relational algebraic operations (e.g., joins) on the views. These operations may be specified in a relational query language such as SQL, thereby allowing a graph query to be performed by executing a SQL query on the calculated views.

Changing the information in the underlying tables in which the RDF information is stored may affect the structure of the graph, and thus may affect the calculated views. Thus, various triggers are implemented that cause certain views to be recalculated when certain types of changes are made to the information stored in the tables. For example, the kinds of predicates that will be recognized in the graph may be defined in specific rows of the tables. Each predicate may have its own view, so when the tables are changed to add or delete a predicate from the graph, a view may be created or deleted accordingly. Other types of modifications may trigger other changes to the views, as more particularly described below.

U.S. patent application Ser. No. 12/141,067, which was filed Jun. 17, 2008 and is incorporated herein by reference, describes a way of representing information in the form of a relational database. In general, different aspects of the data are represented in different tables. For example, relations and objects are different types of data classes (where a “relation” is approximately the same as what has been called a “predicate” above, and an “object,” in this context, is approximately the same as an entity, such as the entities that might be the subject or object of a predicate). Thus, one table might contain a list of all of the different classes. The table might have two columns: one indicating whether the class described by a given row is a relation or an object, and another indicating the name of the class. So, if “owns” is an example of a relation, one row might be the 2-tuple: (“relation”, “owns”). Or, if “human” is an example of an object, then another row might be the 2-tuple: (“object”, “human”). And so on. Similarly, classes may have members. For example, a “human” might have a name, a gender, and a birthday. So, another table might list all of the different members of the classes, containing rows such as (“human”, “name”), (“human”, “gender”), (“human”, “birthday”). Other tables might identify the various instances of the classes. E.g., if Alice and Bob are both humans, then another table (e.g., a class-instance table) might contain the 2-tuples (“human”, “Alice”), and (“human”, “Bob”), thereby declaring “Alice” and “Bob” to be instances of the “human” class. Other tables might assign specific values to the members of the various class instances. E.g., a table might indicate that Alice's gender, or might declare the existence of various relations between objects.

The specific tabular structure described in the above-mentioned patent application is merely an example, and the present subject matter is not limited to the structures shown in that application. As applied to the present subject matter, however, the relevant aspect of that application is that the absence of a table that has the subject of a triple in one column and the object of the triple in another column makes it difficult to do graph-type reasoning on the triples using relational query processing techniques. The subject matter herein provides for the creation and maintenance of views that correspond closely with the RDF triples that define a graph, thereby allowing graph-based reasoning to be performed on the views in a relatively natural way by a relational query processor.

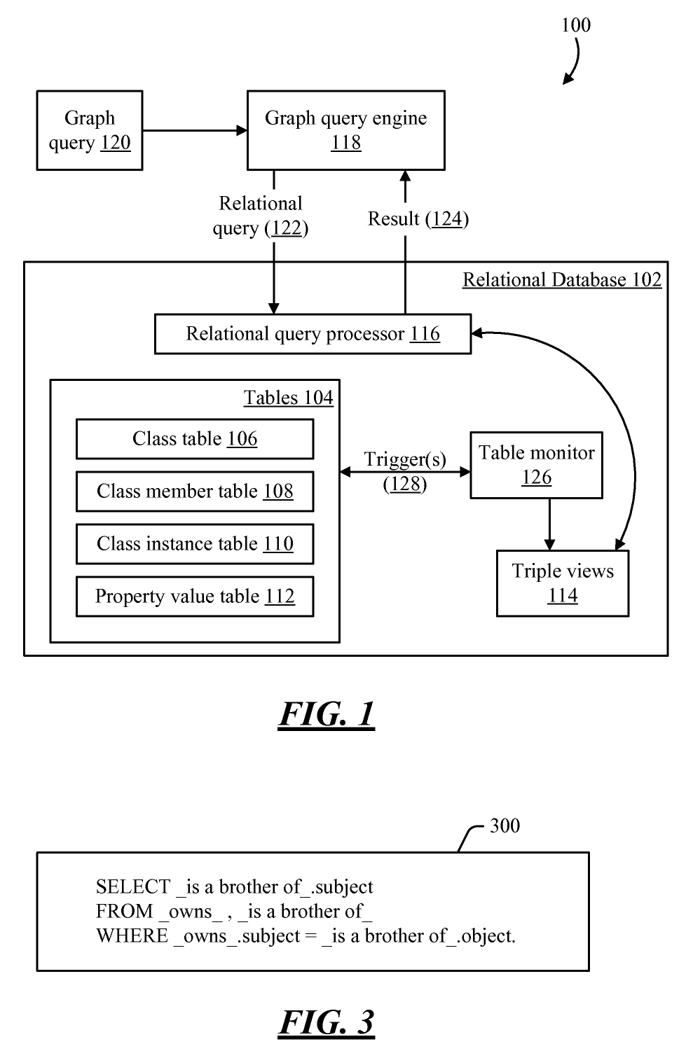

Turning now to the drawings, FIG. 1 shows an example system 100 in which graph queries may be processed on information that is stored in a relational database.

Relational database 102 stores information in the form of various tables 104. For example, tables 104 may include class table 106, class member table 108, class instance table 110, and property value table 112. The foregoing are some examples, although tables 104 could include types of tables other than those shown.

Class table 106 may describe the various classes of entities and relations. For example, class table may contain information that defines “human,” “automobile,” and “airplane” as classes of entities, and “_owns_”, “_works with_” and “_is a brother of_” as classes of relations that may exist between the entities. (In the description herein, the names of relations may be surrounded by underscores, where appropriate, to distinguish names of relations from names of entities.) In one example, class table 106 may represent this information with a column for a class type and a column for the class name. Thus, in order to declare that “human” is a class of entities, the table may have, as a row, the 2-tuple (“entity”, “human”). Similarly, the 2-tuple (“relation”, “_owns_”) declares that “_owns_” is a class of relation that may exist between entities.

Class member table 108 may describe the various members of classes. For example, entities in the “human” class may have a name, a gender, and a birthday. Thus, in order to declare that entities in the human class may be associated with this type of information, class member table 108 may have a column that contains the names of classes, and a column that contains the membership of the various classes. Thus, in such a table, the 2-tuples (“human”, “name”), (“human”, “gender”), (“human”, “birthday”), declare that name, gender, and birthday are members of the “human” class, thereby indicating that name, gender, and birthday are properties that an entity in the human class may have. Relations may also have class members. For example, if “Alice” and “Alice's car” are two entities (of class “human” and “automobile,” respectively), then the “_owns_” relation may describe the relationship between those two entities (e.g., “_owns_(“Alice”, “Alice's car”)”). However, in addition to the bare fact of ownership, there may be additional information surrounding that ownership (e.g., the purchase price and the entity from whom the car was purchased). Thus, 2-tuples in class member table 108 of the form (“_owns_”, “purchased from”) and (“_owns_”, “purchase price”) may declare that such information may be associated with the “_owns_” relationship.

Class instance table 110 may identify the particular entities that are members of a specific class. Class instance table 110 may contain a column that stores class names, and another column that stores instances of the class. For example, if “Alice,” “Bob,” and “Ted” are all humans, and if “Alice's car” is an automobile, then class instance table 110 may contain 2-tuples such as (“human”, “Alice”), (“human”, “Bob”), (“human”, “Ted”), and (“automobile”, “Alice's car”). These tuples declare the “Alice”, “Bob”, and “Ted” are all instances of the “human” class, and “Alice's car” is an instance of the automobile class. There may also be instances of relation classes. For example, “_owns_” is an abstract relation that may be applied to entities, but “Alice owns Alice's car” and “Ted owns Ted's car” are specific instances of the “_owns_” relation, and thus may be expressed in class instance table 110 through the 2-tuples (“_owns_”, “Alice owns Alice's car”) and (“_owns_”, “Ted owns Ted's car”).

Property value table 112 may associate specific values with the members of a particular class instance. For example, class instance table 110 declares that “Alice” is an instance of the class “human”. As described above, humans may have certain information associated with them—e.g., name, gender, and birthday. Thus, property value table 112 may associate specific values with these class members. Property value table 112 may contain a column identifying a class instance, a column identifying a specific member of the class, and a value to be assigned to the identified member of the identified class instance. For example, the 3-tuples (“Alice”, “name”, “Alice”), (“Alice”, “gender”, “female”), and (“Alice”, “birthday”, “Dec. 30, 1970”) indicate specific values for Alice's name, gender, and birthday. (It is noted that “Alice” is both Alice's actual name and the canonical representation of her class instance. Alice's name, and the label used to identify her class instance, happen to be the same word, but this might not be true for other class instances. For example, the human instance that has been identified above by the canonical identifier “Bob” might have a “name” value of “Robert”.)

In the above, examples, the various tables are describes as having two or three columns of information, and thus it has been indicated that certain information could be represented in the form of a 2-tuple or 3-tuple. However, the tables could have additional columns (e.g., keys, indices, or any other information), and thus the arity of the tuple would be adjusted accordingly. Furthermore, the member attributes themselves (e.g., name, gender, and birthday in the example above) could be stored in a common tuple for each instance of a human entity. Thus, the description above is not limited to tables having any particular number of columns; the specific number of columns in a table, and the specific number of elements in a tuple or row of the table, are offered above merely as examples.

As noted above, techniques described herein are not limited to specific types of tables, such as tables 106-112 described above. However, as can be seen from these examples, tables may store information from which RDF-triple-like facts (or other PRT-type facts) can be gleaned, even if the tables are not particularly compatible with the evaluation of graph queries by a relational query processor. For example, in the examples above, the triple _owns_(“Alice”, “Alice's car”) can be gleaned from the tables. In particular, class instance table 110 contains the tuple (“_owns_”, “Alice owns Alice's car”), thereby stating that there is an instance of the _owns_relation involving “Alice” and “Alice's car.” However, because of the way that these tables are laid out in relational database 102, it is difficult to extract the owner and the ownee from the tables using the relational algebra that relational query engines implement. For example, one might want to issue a query to discover the brother (if any) of the human who owns “Alice's car”. In order to answer this type of query, it is helpful to first determine who is the owner of Alice's car. (It might seem self-evident that “Alice” is the owner of “Alice's car.” However, “Alice's car” is simply the name of a particular instance of the automobile class, and this name has no significance in determining ownership relationships in this example. In the examples described above, the only formal indication that the “_owns_” relationship exists between the human instance named “Alice” and the automobile instance that happens to be named “Alice's car” is the fact that the tuple (“_owns_”, “Alice owns Alice's car”) appears in property instance table 110.) Thus, in order to determine who the owner of “Alice's car” is, one may look in property instance table 110 to determine what “_owns_” relationships exist. As noted above, there is a tuple indicating that “Alice owns Alice's car” is a instance of the “_owns_” relation. However, in the sense of an RDF graph, this ownership relation has three pieces of information—the predicate “_owns_”, the subject “Alice”, and the object “Alice's car”. Since these pieces of information appear together in one column, it may not be possible to reason on the individual pieces of information in a relational algebraic sense.

Relational query processors, such as those that process SQL language queries, typically implement the relational algebra, which is an algebra of tables in which the basic units on which operations are performed are tables, rows, and columns. Relational query processor can perform various algebraic operations, such as Cartesian product (the “comma” operator in SQL), selection of rows based on criteria (invoked by the “where” keyword in SQL), projection of a table into a subset of its columns (incongruously referred to by the “select” keyword in SQL), set operations on selections of rows (the “except”, “union”, and “union all” keywords in SQL), and various types of joins. For example, a relational query processor can be used to perform an operation such as “calculate the Cartesian product of Table A and Table B, and return the first and third columns of those rows where the value in the first column matches the value in the fourth column.” With regard to the subject matter that is described herein, a problem that arises is that the ability to perform this type of operation in a natural relational algebraic way depends on the atomic units of information to be operated upon being contained in different cells of the table. Since the ownership relationship between “Alice” and “Alice's car” is stated in a single column of a single table (i.e., without the subject and object being in separate cells), performing operations on these entities, separately, involves performing some type of text processing (or other data processing) to extract the separate entities from a cell of the table. This type of extraction can be done, since many implementations of the SQL language, and other relational query processors, allow procedural language code (such as Visual Basic, Java, etc.) to be inserted into a SQL query. These queries will produce sets of edges, which are then combined using the set operations in SQL to provide the graph query processor a single view of the triples contained in the database. This approach provides the graph query processor a way to access all the facts contained in the relational database, but does not preserve enough of the specifics of the original queries used to form efficient relational queries on the original database. In particular, if there is any table in the relational database that can freely form predicates (such as a table that listed the kind of relationship in a column), the relational query processor will be unable to exclude this table from any query that references the union of all edges, as the graph query processor would. It would be more efficient to pre-calculate views that represent RDF facts on a per-predicate basis, and then to process graph queries by performing relational queries on these views. For example, if there is a view (named, e.g., “OWNS”) that contains two columns—a subject and an object—for all instances of the “_owns_” relation, then it is relatively easy to extract the owner of “Alice's car”, simply using a the SQL query “select subject from OWNS where OWNS.object=‘Alice's car’”. Relational reasoning on the extracted information can then proceed. For example, to answer the hypothetical query above of “who is the brother of the owner of Alice's car”, if there is a view called “BROTHER” that stores instances of the “_is a brother of_” relation, then one might answer the query with the SQL statement “select subject from OWNS, BROTHER where OWNS.subject=BROTHER.object.”

The subject matter herein may be used to create the views that allow graph queries to be answered efficiently by a relational query processor.

Returning now to a discussion of FIG. 1, relational database 102 contains triple views 114. Triple views 114 are tabular representations of the triples implied by the information contained in tables 104. For example, each relation may have its own view, with a “subject” column and an “object” column. So, by looking at the view for the “_owns_” relation, it is possible to determine the pairs of entities to which the “_owns_” relation applies—e.g., (“Alice”, “Alice's car”) might be a row of the “_owns_” relation. A relational query processor 116 may perform various types of reasoning on triple views 114. Thus, a graph query engine 118 may receive a graph query 120 that requests an answer based on entities and relations defined in tables 104. When graph query engine 118 receives that graph query in a language such as SPARQL, graph query engine 118 may convert the query into relational query 122 (e.g., a SQL query), which graph query engine 118 may provide to relational query processor 116. Relational query processor 116 may then process relational query 122 by performing operations on triple views 114. Relational query engine may then provide results 124 back to graph query engine 118, which may then present the results to the agent (e.g., the user) that supplied the query, or may otherwise take some form of tangible action based on the results.

Triple views 114 may be created and/or maintained by table monitor 126. Table monitor 126 monitors tables 104 to determine whether changes are taking place to the content of tables 104, and whether those changes imply changes to the triple views. For example, class table 106 has rows that list the various relations that exist. If a row is added to that class table 106 indicating that a new class of relation has been added, then a view may be created corresponding to that relation. Conversely, if a row is deleted from class table 106 indicating that a relation has been removed, then the view for that relation may be removed. Additionally, if class instances are added or deleted in ways that would affect the views, then the views may be changed to reflect those additions or deletions. For example, if the instances of the “_owns_” relation that are shown in class instance table indicate that “Alice owns Alice's car” and “Ted owns Ted's car”, and if the latter of these two class instances is removed, then the corresponding row from the “_owns_” view may be removed from that view. Or, if the “human” class instance named “Alice” is removed, then all of the relations of which Alice is a subject or object may be updated to reflect that “Alice” no longer exists.

Triple views 114 may change dynamically in response to changes in the underlying tables 104, so table monitor 126 may employ various triggers 128 to determine when to update triple views 114. For example, relations may be added or removed by adding a row to, or deleting a row from, class table 106. Thus, the addition or deletion of such a row may trigger the creation or deletion of a view corresponding to the added or removed relation. Moreover, a particular instance of a relation, such as the “_owns_” relation, (e.g., “Alice owns Alice's car”) may be added or deleted, which may trigger an update to the “_owns_” view, by adding or deleting a row from that view.

Table monitor 126 may create the views using a relational query and appropriate text processing logic (or other data extraction logic). For example, if table monitor 126 creates a view for every relation, then table monitor may implement a view for that relation by using a select query on class instance table 110 (to extract the class instances from that table), and then by extracting the relevant information from the class instance. For example, if class instance table contains two columns named “class” and “instance”, and has the tuples (“_owns_”, “Alice owns Alice's car”) and (“_owns_”, “Ted owns Ted's car”), database monitor 126 may create a view called “_owns_”. This view may be created by using a query such as “select instance from class_instance_table where class=‘_owns_’”. This query retrieves, from a class instance table, those cells in the table that define instances of an “_owns_” relationship. The query may then specify additional processing to be performed on the cell to extract the subject and object from the cell, and may then place that subject and object in the “_owns_” view. Depending on implementation, table monitor 126 may store triple views 114 in durable storage, or may calculate the views dynamically whenever the views are used. It is noted that the graph query engine could facilitate inserts, deletes and modifications of graph structures. Additionally, the graph query engine could be extended to aid directly in maintenance of the views (as compared with view maintenance be driven as a side effect of changes at the relational database level).

FIG. 2 shows an example of how data stored in tables may be converted to views. As described above in connection with FIG. 1, the set of tables 104 in relational database 102 may include class instance table 110. FIG. 2 shows an example of class instance table 110. In this example, it is presumed that there are various classes named “human,” “automobile,” “_owns_”, “_works with_”, and “_is a brother of_”, as described above. Class instance table 110 has columns named “class” and “class instance.” Thus, class instance table 110 is a collection of data about which class instances exist, and what those class instances are. So, class instance table indicates that “Alice”, “Bob”, and “Ted” are all instances of the class human, that “Alice's car” and “Ted's car” are all instances of the class “automobile”, and so on.

An appropriate component (e.g., table monitor 126) may create triple views 114 to reflect instances of the various relations that exist. Example class instance table 110 shows that there are three relation classes involving four relation class instances: i.e., “Alice owns Alice's car” and “Ted owns Ted's car” are instances of the “_owns_” class; “Bob works with Alice” is an instance of the “_works with_” class; and “Bob is a brother of Ted” is an instance of the “_is a brother_” class. Table monitor 126 may, upon examination of class instance table 110, detect that there are three different relation classes in class instance table 110. Thus, table monitor 126 may create three views 202, 204, and 206 corresponding to the three different relation classes. View 202 corresponds to the “_owns_” relation; view 204 corresponds to the “_works with_” relation; and view 206 corresponds to the “_is a brother of_” relation. Each view may be named after the relation whose instances it represents.

Since there are two instances of the “_owns_” relation, view 202 has two rows, each representing one of the instances. The “_works with_” and “_is a brother of_” relations each have one instances, so views 204 and 206 each have one row. In the example of FIG. 2, the columns of each view are labeled “subject” and “object”, thereby indicating the role, within a predicate, that the entities named in those columns have. However, the columns of the views could have any names.

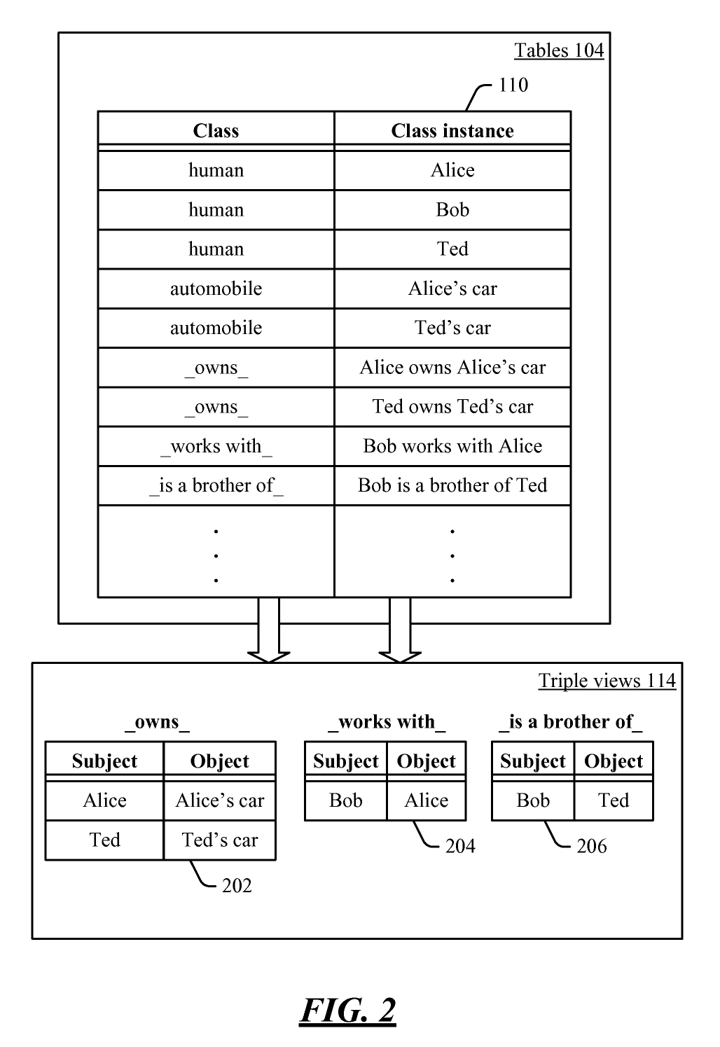

With PRTs being represented as the type of views shown in FIG. 2, it is possible to perform graph-based reasoning on the PRTs using relational algebra. For example, FIG. 3 shows an example relational query 300 that may be used to identify the brothers of any humans who own cars. Query 300 may be generated by a graph query engine (e.g., a SPARQL engine). Since query 300 seeks to find a list of people who are brothers of car owners, query 300 calculates the product of the “_owns_” and “_is a brother of_” views, identifies those rows where the subject from the “_owns_” view is the same as the object of the “_is a brother_” view. The subjects of the identified rows of from the “_is a brother of_” relation are then presented.

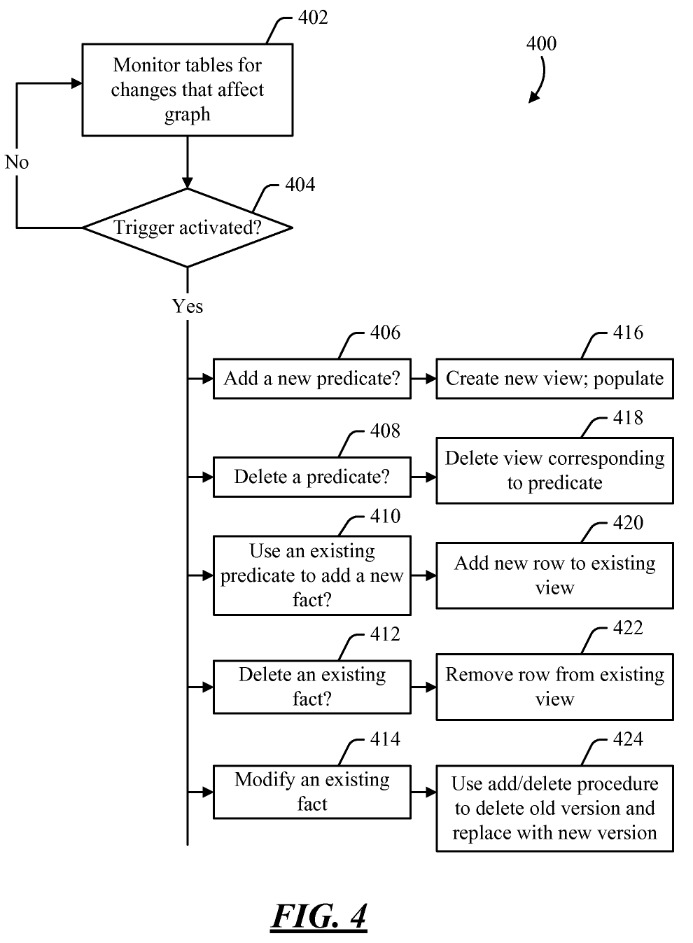

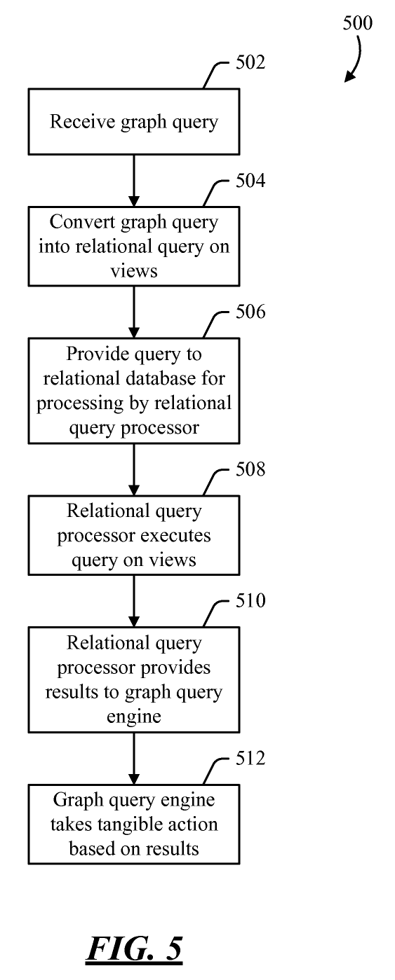

FIG. 4 shows an example process 400 in which views may be updated and/or created. Before turning to a description of FIG. 4, it is noted that each of the flow diagrams contained herein (both in FIG. 4 and in FIG. 5) shows an example in which stages of a process are carried out in a particular order, as indicated by the lines connecting the blocks, but the various stages shown in these diagrams may be performed in any order, or in any combination or sub-combination.

At 402, tables in a database are monitored for changes that would affect the graph implied by the information stored in the tables.

At 404, it is determined whether a trigger to update the views has been activated. As noted above, a triple represents two vertices and an edge of a graph, so any change that either creates or destroys a triple activates a trigger. If no trigger is detected, the process 400 may loop indefinitely to wait for a trigger. If a trigger is detected, then the trigger is processed in the manner described below, depending on what type of event has set off the trigger.

Events 406, 408, 410, 412 and 414 are various types of events that may trigger an update to the views. Each of events 406-414 leads to a particular type of action that may be taken to carry out the update.

If the event that triggers an update is the adding of a new predicate (or “relation”) (event 406), then process 400 may create and populate a new view (at 416). As noted above, each predicate or relation corresponds to a view, where the view is named after the relation that it represents and has columns for the subject and object. Such a view may be created at 416.

If the event that triggers an update is the deletion of a predicate or relation (event 408), then process 400 may remove the view that corresponds to that relation or predicate (at 418).

If the event that triggers an update is the use of a new predicate to add a new fact (event 410), then the new fact is added to the view that exists for that predicate (at 420). For example, if there is already an “_owns_” predicate and the event is to add a new “_owns_” relationship between two entities, then handling the event does not involve creating a new view since a view for the “_owns_” predicate already exists. Rather, handling the event is performed by updating the view to include a new entry for the new “_owns_” relation. For example, if the relation “Joe owns the motorcycle” is added to class instance table 110 (shown in FIG. 2) as an instance of the “_owns_” relation, then the tuple (“Joe”, “the motorcycle”) may be added to the “_owns_” view to reflect that a new fact involving the “_owns_” predicate has been created.

If the event that triggers an update is the deletion of an existing fact (event 412), then the entry corresponding to that fact is deleted from the appropriate view (at 422). For example, “Joe owns the motorcycle” is an instance of the “_owns_” relation in class instance table 110, and if that instance is deleted, then the corresponding row may be deleted from the “_owns_” view.

If the event that triggers an update is to modify an existing fact or predicate (event 414), then the event may be handled by a combination additions and deletions (at 424). For example, if the instance “Joe owns the motorcycle” is changed to “Joe owns the Yamaha motorcycle”, this change may be handled by deleting the (“Joe”, “the motorcycle”) tuple from the “_owns_” view and adding (“Joe”, “the Yamaha motorcycle”) to that same view.

FIG. 5 shows an example process 500 in which a graph query may be processed using techniques described herein.

At 502, a graph query is received. For example, a SPARQL query may be received by a SPARQL engine. At 504, the graph query is converted into a relational query. For example, a SPARQL engine may convert a SPARQL query into a SQL query to be processed by a relational database. The SPARQL engine may have knowledge of the triple views that are described above, and may formulate the query in terms of those views. (It is noted that a graph query processor may be able to reason over the defined views as a way of inferring existing predicate relationships.)

At 506, the query may be provided to the relational database for processing by the relational database's query processor. At 508, the relational query executes the query, which may include operations on the views described herein.

At 510, the relational query processor provides, to the graph query engine, the results of having executed the relational query. The graph query engine may receive the results, and may take a tangible action based on the result (at 512). For example, the graph query engine may communicate the result of the query to the user who issued the graph query. Or, the graph query engine may use the result of the query as a basis to perform some physical task (e.g., write to a disk, turn a device on or off, generate paper communications, etc.). The foregoing are examples of tangible actions that may be performed.

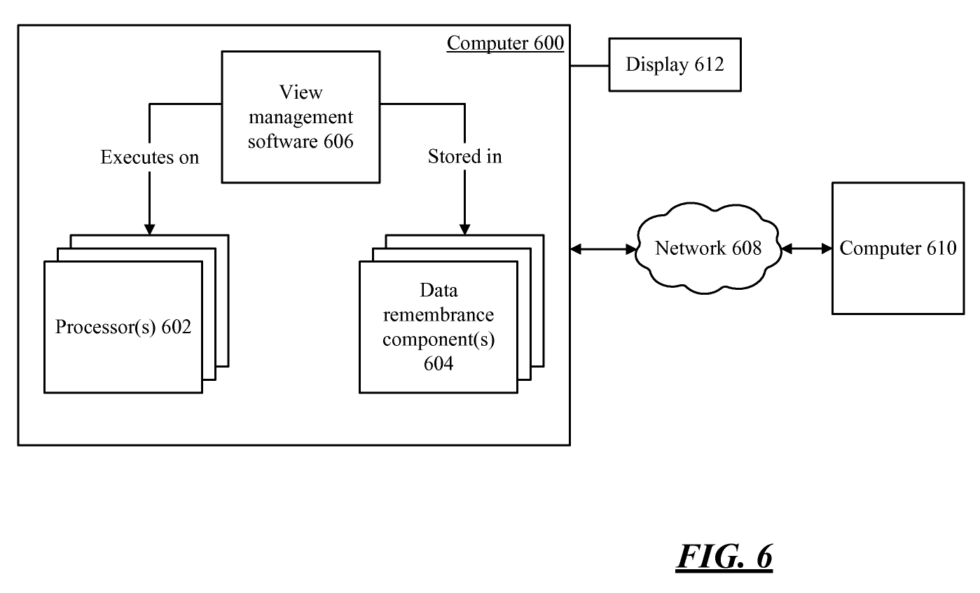

FIG. 6 shows an example environment in which aspects of the subject matter described herein may be deployed.

Computer 600 includes one or more processors 602 and one or more data remembrance components 604. Processor(s) 602 are typically microprocessors, such as those found in a personal desktop or laptop computer, a server, a handheld computer, or another kind of computing device. Data remembrance component(s) 604 are components that are capable of storing data for either the short or long term. Examples of data remembrance component(s) 604 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 600 may comprise, or be associated with, display 612, which may be a cathode ray tube (CRT) monitor, a liquid crystal display (LCD) monitor, or any other type of monitor.

Software may be stored in the data remembrance component(s) 604, and may execute on the one or more processor(s) 602. An example of such software is view management software 606, which may implement some or all of the functionality described above in connection with FIGS. 1-5, although any type of software could be used. Software 606 may be implemented, for example, through one or more components, which may be components in a distributed system, separate files, separate functions, separate objects, separate lines of code, etc. A computer (e.g., a personal computer, a server computer, etc.) in which a program is stored on hard disk, loaded into RAM, and executed on the computer's processor(s) typifies the scenario depicted in FIG. 6, although the subject matter described herein is not limited to this example.

The subject matter described herein can be implemented as software that is stored in one or more of the data remembrance component(s) 604 and that executes on one or more of the processor(s) 602. As another example, the subject matter can be implemented as instructions that are stored on one or more computer-readable storage media. Such instructions, when executed by a computer or other machine, may cause the computer or other machine to perform one or more acts of a method. The instructions to perform the acts could be stored on one medium, or could be spread out across plural media, so that the instructions might appear collectively on the one or more computer-readable storage media, regardless of whether all of the instructions happen to be on the same medium.

Additionally, any acts described herein (whether or not shown in a diagram) may be performed by a processor (e.g., one or more of processors 602) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, computer 600 may be communicatively connected to one or more other devices through network 608. Computer 610, which may be similar in structure to computer 600, is an example of a device that can be connected to computer 600, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method of answering a query, comprising:
using a computer processor to perform acts comprising:
creating a plurality of views based on information stored in a relational database, the information being stored in tables in the relational database, the information defining a plurality of entities and a plurality of relationships between pairs of entities, each of the views corresponding to one of the plurality of relationships;
receiving a graph query that requests an answer based on said entities and said relationships;
converting said graph query into a relational query that is defined in terms of operations on the views;
using a relational query processor to answer said relational query; and
providing a result based on answering of said relational query.

2. The method of claim 1, wherein said graph query is specified in SPARQL.

3. The method of claim 1, wherein said graph query is received by a graph query processor, and wherein said converting is performed by said graph query processor.

4. The method of claim 3, wherein the result is provided to the graph query processor, and wherein the method further comprises:
using the graph query processor to present the result to a user who supplied the graph query.

5. The method of claim 1, further comprising:
using the computer processor to perform a tangible action that is based on the graph query.

6. The method of claim 1, wherein each of said relationships has a name, and wherein each of the views comprises the name of a relationship to which the view corresponds.

7. The method of claim 1, wherein each of the views comprises two columns, wherein a first one of the columns stores a subject of the relationship to which the view corresponds, and wherein a second one of the columns stores an object of a relationship to which the view corresponds.

8. The method of claim 1, wherein said relational database comprises a table in which an instance of a relationship is in a single column of said table, without a subject and an object of said relationship being in separate columns in said table, and wherein said creating creates said views based on said table.

9. A system comprising:
a relational database that comprises:
a plurality of tables that store information about entities and about relationships between said entities;
a table monitor that creates views of information stored in said tables, each of said views corresponding to a particular relationship identified by said tables, each of said views comprising a first column that stores a subject of the relationship to which the view corresponds and a second column that stores an object of the relationship to which the view corresponds; and
a relational query processor that processes relational queries on said views; and
a graph query engine that receives a graph query, that converts said graph query into a relational query that specifies operations to be performed on said views to answer said graph query, that provides said relational query to said relational query processor, and that receives a result from said relational query processor.

10. The system of claim 9, wherein said table monitor is triggered to update said views when a relationship is added to said tables, said table monitor updating said views by adding a new view corresponding to the added relationship.

11. The system of claim 9, wherein said table monitor is triggered to update said views when a relationship is deleted from said tables, said table monitor updating said views by deleting an existing view that corresponds to the relationship that is deleted from the tables.

12. The system of claim 9, wherein said table monitor is triggered to update said views when a new instance of a relationship is added to said tables, said table monitor updating said views by identifying a view to which said relationship corresponds and by adding a new row to the identified view that contains a subject and an object of the new instance.

13. The system of claim 9, wherein said table monitor is triggered to update said views when an instance of a relationship is deleted from said tables, said table monitor updating said views by identifying a view to which said relationship corresponds, by identifying a row containing a subject and an object of the deleted instance, and by removing the identified row from the view.

14. The system of claim 9, wherein said tables do not include a table that has a first column that stores a subject of a given relationship and a second column that stores an object of said given relationship.

15. The system of claim 9, wherein said query comprises a SPARQL query, and wherein said graph query engine converts said SPARQL query into said relational query.

16. The system of claim 9, wherein said table monitor includes, in each of the views, a name of a relationship to which a given view corresponds.

17. One or more computer-readable storage media that store executable instructions that, when executed by a computer, cause the computer to perform acts comprising:
monitoring a relational database to identify changes in the relational database, said relational database storing a table that specifies instances of relations, each instance of a relation identifying a subject and an object to which the relation applies, said table storing said subject and said object in a single column, said table not having separate columns to store said subject and said object;
determining that said table has been modified in a way that changes which relations, or instances of relations, exist; and
based on modifications to said table, updating a set of views, each of the views representing subjects and objects that are related by a given relation.

18. The one or more computer-readable storage media of claim 17, wherein said determining finds that said table has been modified by addition of a new relation to said table, and wherein the acts further comprising:
creating a new view that corresponds to said new relation.

19. The one or more computer-readable storage media of claim 17, wherein said determining finds that said table has been modified by addition of a new instance of a first relation to said table, and wherein the acts further comprise:
identifying a first one of the views that corresponds to said first relation; and
adding to said first one of the views a row that comprises a subject of said new instance in a first column of said first one of the views, and an object of said new instance in a second column of said first one of the views.

20. The one or more computer-readable storage media of claim 17, wherein each given one of said views comprises:
a name of the relation to which the given view corresponds;
a first column that stores subjects of the relation; and
a second column that stores objects of the relation.
